(19) United States
(12) Patent Application Publication
(10) Pub. No.: US 2024/0051212 A1
(43) Pub. Date: Feb. 15, 2024

(54) IMPROVED POLYESTER COMPOSITION FOR EXTRUSION BLOW MOLDED CONTAINERS

(71) Applicant: Auriga Polymers, Inc., Charlottle, NC (US)

(72) Inventors: Jennifer Shannon King, Spartanburg, SC (US); Jason Alan Smith, Boiling Springs, SC (US)

(21) Appl. No.: 18/258,830

(22) PCT Filed: Dec. 17, 2021
(86) PCT No.: PCT/US2021/064058

§ 371 Date: Jun. 22, 2023

Related U.S. Application Data
(60) Provisional application No. 63/288,894, filed on Dec. 13, 2021.
(60) Provisional application No. 63/129,305, filed on Dec. 22, 2020.

(51) Int. Cl. B29C 49/00; B29C 49/04

(52) U.S. Cl. CPC B29C 49/0005; B29C 49/04; B29L 2031/7158

(57) ABSTRACT

The present invention relates to a polyester resin for extrusion blow molded bottles comprising a branched aliphatic glycol and a branching comonomer.

### CROSS REFERENCE TO RELATED PATENT APPLICATIONS

The present patent application claims the benefit of priority of co-pending Application No PCT/US2021/064058, filed Dec. 17, 2021, and entitled “Improved Polyester Composition for Extrusion Blow Molded Containers” which claims the benefit of priority of U.S. Provisional Patent Application No. 63/129,305, filed Dec. 22, 2020, and entitled “Improved Polyester Composition For Extrusion Blow Molded Containers” and U.S. Provisional Patent Application No. 63/288,894, filed Dec. 13, 2021, and entitled “Improved Polyester Composition For Extrusion Blow Molded Containers,” the contents of which are incorporated in full by reference herein.

### FIELD OF THE INVENTION

This invention relates to polyester polymers, and more particular to polyethylene terephthalate copolyesters for transparent extrusion blow molded containers.

### BACKGROUND OF THE INVENTION

Aromatic polyesters generally are semi-crystalline and have low melt strength. Containers made from polyethylene terephthalate (PET), with minor amounts of a modifying comonomer, by the injection stretch molding process (ISBM) are the most common transparent container on the market. However, the ISBM process is limited to uniform shapes and cannot produce bottles with a handle. Handles are a desirable feature for larger bottles and containers to facilitate handling by the consumer. Such larger bottles and containers with handles can be produced by the extrusion blow molding (EBM) process.

A typical EBM process involves: a) melting the resin in an extruder b) extruding the molten resin through a die to form a tube of molten polymer (a parison) c) clamping a mold having the desired finished shape around the parison d) blowing air into the parison, causing the extrudate to stretch and expand to fill the mold e) cooling the molded container f) ejecting the container from the mold and g) removing excess plastic (flash/flashing) from the container.

The hot parison that is extruded in this process often must hang for several seconds under its own weight prior to the mold being clamped around it. During this time, the extrudate must possess high melt strength—a feature that enables the material to resist stretching, flowing, and sagging that would cause uneven distribution in the parison and thinning of the parison walls. The sag of the extruded parison is directly related to the weight of the parison, whereby larger and heavier parisons will have a greater tendency to sag. Melt strength is directly related to the polyester resin's viscosity, under zero shear rate, and temperature when the molten extrudate exits the die. However, a resin with high melt strength, or high melt viscosity at zero shear rate, is too viscous to be extruded in the extruder and pumped through the die without using high temperatures which cause the polymer to degrade and lose its melt viscosity. Therefore, an optimal-polyester resin, tailored for EBM end uses, must have a rheology such that the viscosity at the shear rates associated with the extrusion process, generally 100 to 1000 s⁻¹, is lower than the viscosity at zero shear rate (i.e. it exhibits shear thinning).

The typical PET resins used for ISBM beverage containers are not suitable for EBM due to their relatively low intrinsic viscosities (IV<0.85 dl/g) and high melting points (>245° C.), which gives a low melt strength at temperatures required to process them.

During the EBM process, the molten polyester cannot thermally crystallize on cooling; otherwise, a cloudy container is produced. Unlike the ISBM process, the EBM process produces waste from the flash that has to be cut off the molded container (e.g. clamped sites). This waste (or recycled material) from the EBM process must be ground and blended with virgin resin and dried prior to re-extrusion. This waste (regrind) usually comprises about 40-50% of the feedstock in the EBM manufacturing process.

Prior art has met these requirements for extrusion blow molding by using comonomers such as isophthalic acid (IPA) and 1,4-cyclohexanedimethanol (CHDM) in order to reduce the thermal crystallization rate (Modern Polyesters: Chemistry and Technology of Polyesters and Copolyesters 2003, 246-247). Amorphous copolyesters using CHDM as a comonomer for EBM have been disclosed, for example in U.S. Pat. Nos. 4,983,711; 6,740,377; 7,025,925; 7,026,027; 7,915,374; 8,431,068; 8,890,398; and 2011/0081510. Amorphous copolyesters using IPA as a comonomer have been disclosed, for example in U.S. Pat. No. 4,182,841.

Higher melt strengths at a zero shear rate with shear thinning that reduce the melt viscosity at higher shear rates have been achieved by the use of branching comonomers in copolyesters containing CHDM or IPA as modifying comonomers. Typical branching comonomers such as trimellitic anhydride (TMA) and pentaerythritol (PENTA) were disclosed in U.S. Pat. Nos. 4,132,707 and 4,999,388. To date, the majority of copolyester formulations designed for EBM containers have been essentially amorphous, with the use of branching comonomers in order to achieve the proper balance of both processing as well as good container appearance and performance. However, the inclusion of branching comonomers can give rise to gels which then yield a poor bottle appearance (e.g. elevated haze, decreased gloss, etc.). In addition, a high degree of branching can cause melt fracture at the die, giving the surface of the container a mottled appearance.

Containers made from amorphous copolyesters, when added to the postconsumer PET recycling stream, tend to cause sticking, agglomeration and bridging issues during the drying process. This makes such EBM PET resins unsuitable for reuse in the post-consumer polyester recycle stream that is used in blends with virgin resins for use in the standard container and bottle ISBM process.

Alternatively high melt strength copolyester resins with an ultra-high molecular weight (IV>1.1 dl/g) that contain a low amount of IPA or CHDM can be used to provide the necessary melt strength as they exhibit some degree of shear thinning (U.S. Pat. No. 9,399,700). These ultra-high IV polyester resins have to be processed at higher temperatures which cause the resin to thermally degrade giving not only an increased yellowness in the container but a narrower EBM processing window. Decreasing the temperature leads to melt fracture and a marked increase in the pressure required from the extruder to feed molten polymer to the die. In addition these tough resins are more difficult to cut and to cleanly remove flash from the finished container.

A key requirement for an EBM container is its ability to be dropped with a liquid therein without breaking (i.e. it must possess acceptable drop impact performance when filled). It is well known that amorphous polyesters age with time—this aging affect translates to containers made from amorphous polyesters becoming more brittle with age (i.e. lower impact resistance), and thus more prone to breakage when dropped.

PolyClear® EBM resin (Auriga Polymers Inc., Spartanburg, SC USA) is one commercial resin (partially crystalline) that has been approved by the Association of Postconsumer Plastic Recyclers (APR) for recycling in the postconsumer recycling stream. However this resin suffers from poor aged bottle drop resistance. U.S. Pat. No. 9,815,964 improved the aged drop resistance of this IPA modified-co-branched copolyester resin by the addition of fillers, in particular fumed silica.

Polymers made via step condensation chemistry contain amounts of cyclic comonomer (e.g. cyclic dimer, cyclic trimer, etc.). For example, use of isophthalic acid as a crystallization retardant suffers in that it forms high melting point oligomers that deposit on not only container molds but also cooler surfaces in/around the point of extrusion. These depositions are undesirable as they cause more frequent cleaning and/or downtime for downstream processors/converters.

None of the prior art patents disclose a composition for EBM that meets all the following market needs:
a) approved for recycling in the postconsumer recycling stream, and
b) high melt viscosity at zero shear rate to provide a parison that does not sag, and
c) low melt viscosity at the shear rates in the extruder and die head to reduce the extrusion temperature to minimize degradation and the energy required to melt and extrude the resin, and
d) low deposit formation during the extrusion blow molding process to minimize machine down-time for cleaning, and
e) slow crystallization rate such that the container does not become hazy during the cooling cycle due to the crystallization of the resin.

Therefore, it is highly desirable to discover a novel polyester resin that meets all these requirements for the extrusion blow molding process.

In the broadest sense, the present invention relates to a polyester resin for extrusion blow molded bottles comprising copolyester comprising:
a) alkyl branched aliphatic diol represented by Formula 1:

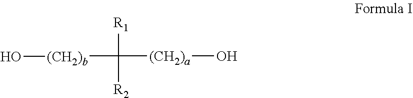

where R₁ is a hydrogen atom or an alkyl group having 1 to 6 carbon atoms, and
R₂ is an alkyl group having 1 to 6 carbon atoms, and a
and b are each independently an integer from 1 to 2,
and
b) branching comonomer.

### BRIEF SUMMARY OF THE INVENTION

In the broadest sense, the present invention relates to the process of preparing EBM bottles from this composition.

In the broadest sense, the present invention relates to the EBM containers made from this composition.

### BRIEF DESCRIPTION OF THE DRAWINGS

The present invention is illustrated and described herein with reference to the various drawings, in which like reference numbers denote like method steps and/or system components, respectively, and in which:

### DETAILED DESCRIPTION OF THE INVENTION

The ranges set forth herein include both numbers at the end of each range and any conceivable number there between, as that is the very definition of a range.

Polyester EBM resins are generally prepared by the addition of comonomers to retard the crystallization rate of the polyester resin together with a multifunctional branching comonomer to increase the melt strength and provide the resin with a shear thinning rheological behavior.

The polyester compositions suitable for use in this invention typically comprise:
(a) a diacid component comprising 95 to 100 mole percent of residues of terephthalic acid, naphthalene dicarboxylic acids or mixtures thereof, based on the total mole percent of diacid residues in the polyester compositions, and
(b) a glycol component comprising 90 to 98 mole percent of residues of ethylene glycol, diethylene glycol or mixtures thereof, based on the total mole percent of glycol residues in the polyester compositions, and
(c) a glycol component comprising 2 to 10 mole percent, based on the total mole percent of glycol residues in the polyester compositions, of an aliphatic branched glycol represented by the following Formula I:

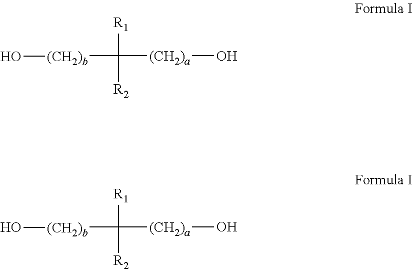

where R₁ is a hydrogen atom or an alkyl group having 1 to 6 carbon atoms, and R₂ is an alkyl group having 1 to 6 carbon atoms, and a and b are each independently an integer from 1 to 2, and
d) a branching comonomer.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching comonomers. Typically, the difunctional carboxylic acid can be a dicarboxylic acid and the difunctional hydroxyl compound can be a dihydric alcohol such as, for example, glycols and diols. The term “glycol” as used herein includes, but is not limited to, diols, glycols, and/or multifunctional hydroxyl compounds, for example, branching comonomers. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone, resorcinol or other heterocyclic diols, and isosorbide, for example.

The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, and/or mixtures thereof. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make polyester.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and glycol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 1 mole % isophthalic acid, based on the total acid residues, means the polyester contains 1 mole % isophthalic acid residues out of a total of 100 mole % acid residues. Thus, there is 1 mole of isophthalic acid residues among every 100 moles of acid residues. In another example, polyester containing 1.5 mole % diethylene glycol out of a total of 100 mole % glycol residues has 1.5 moles of diethylene glycol residues among every 100 moles of glycol residues.

In other polyesters of the invention, the glycol component employed in making the polyesters useful in the invention can comprise, consist essentially of, or consist of ethylene glycol and one or more difunctional glycols chosen from diethylene glycol, 1,2-propanediol, 1,5-pentanediol, 1,6-hexanediol, and mixtures thereof. The preferred glycol is ethylene glycol.

In addition to terephthalic acid and/or dimethyl terephthalate, the dicarboxylic acid component of the polyesters useful in the invention can comprise up to 5 mole %, or up to 1 mole % of one or more modifying aromatic dicarboxylic acids. Examples of modifying aromatic dicarboxylic acids which may be used in this invention include, but are not limited to, 4,4′-biphenyldicarboxylic acid, 1,4-, 1,5-, 2,6-, 2,7-naphthalenedicarboxylic acid, and trans-4,4′-stilbenedicarboxylic acid, and esters thereof. Heterocyclic dicarboxylic acid, for example 2,5-furan dicarboxylic acid may also be used. The preferred modifying aromatic dicarboxylic acid is 2,6-naphthalene dicarboxylic acid.

The dicarboxylic acid component of the polyesters useful in the invention can be further modified with up to 5 mole % or up to 1 mole % of one or more aliphatic dicarboxylic acids containing 2 to 16 carbon atoms, such as, for example malonic, succinic, glutaric, adipic, pimelic, suberic, octanoic, azelaic, sebacic, dodecanedioic-dicarboxylic acids, diethyl-di-n-propyl malonate, dimethyl benzyl-malonate, 2,2-dimethyl-malonic acid and 2,3-dimethyl glutaric acid. The preferred aliphatic dicarboxylic acid is adipic acid.

The polyesters of the invention can also comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 to about 5% by weight, or about 0.1 to about 2% by weight, based on the total weight of the polyester.

In addition, the polyester compositions and the polymer blend compositions useful in the invention may also contain any amount of at least one additive, for example, from 0.01 to 2.5% by weight of the overall composition common additives such as colorants, dyes, mold release agents, flame retardants, plasticizers, stabilizers, including but not limited to, UV stabilizers, thermal stabilizers and/or reaction products thereof, and impact modifiers. Examples of typical commercially available impact modifiers well known in the art and useful in this invention include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. For transparent EBM containers the refractive index of these additives must closely match the refractive index of the polyester composition to prevent a hazy container. Residues of such additives are also contemplated as part of the polyester composition.

In addition, certain agents which tone the polymer can be added to the melt. A bluing toner can be used to reduce the yellowness of the resulting polyester polymer melt phase product. Such bluing agents include cobalt salts, blue inorganic and organic toner(s) and the like. In addition, red toner(s) can also be used to adjust the redness. Organic toner(s), e.g., blue and red organic toner(s) can be used. The organic toner(s) can be fed as a premix composition. The premix composition may be a neat blend of the red and blue compounds or the composition may be pre-dissolved or slurried in one of the polyester's raw materials, e.g., ethylene glycol.

The total amount of added toner components depends on the amount of inherent yellow color in the base polyester and the efficacy of the toner. Generally, a concentration of up to about 15 ppm of combined organic toner components and a minimum concentration of about 0.5 ppm are used, with the total amount of bluing additive typically ranging from about 0.5 ppm to about 10 ppm.

Conventional production of polyesters can be achieved by a batch, semi-continuous, or continuous process. A typical polyesterification process is comprised of multiple stages and commercially carried out in one of two common pathways. For a process which employs Direct Esterification, the initial stage of the process reacts the dicarboxylic acids with one or more diols at a temperature of about 200° C. to about 250° C. to form macro-monomeric structures and a small condensate molecule, water. Because the reaction is reversible, the water is continuously removed to drive the reaction to the desired first stage product. The branching comonomer is normally added at this stage of the process. In a like manner, when using diesters (versus diacids), an Ester Interchange process is used to react the ester groups of the diesters and diols with certain well known catalysts such, such as manganese acetate, zinc acetate, or cobalt acetate. After completing the ester interchange reaction these catalysts are sequestered with a phosphorus compound, such as phosphoric acid, to prevent degradation during the polycondensation process.

Next, in the second stage of the reaction, either macro-monomeric structures (Direct Esterification Products) or interchanged moieties (Ester Interchange Products) undergo a polycondensation reaction to form the polymer. In this process, the temperature of the molten mass is increased to a final temperature in the range of about 280° to 300° C. and a vacuum (about 150 Pa) applied to remove excess diols and water. This polymerization is stopped when the required/targeted molecular weight is achieved and/or the maximum molecular weight of the design of the equipment is reached. The polyester is extruded through a die into strands which are quenched and cut into pellets. The catalysts generally used for the polycondensation reaction are compounds containing antimony, germanium, aluminum, titanium or other catalysts known to those skilled in the art, or mixtures thereof. The specific additives used and the point of introduction during the reaction is known in the art and does not form a part of the present invention. Any conventional system may be employed and those skilled in the art can select among various commercially-available systems for the introduction of additives so as to achieve an optimal result. The polyester pellets can be further polymerized to a higher molecular weight by well-known solid state polymerization processing techniques.

The terephthalic acid and/or ethylene glycol are preferably derived from a biomass feedstock rather than a petroleum based feedstock. In addition, the use of chemically recycled terephthalic acid (or dimethyl terephthalate) and ethylene glycol from post-consumer polyester waste is also preferred for the polyesters of this invention. Another preferred method of manufacturing the polyester resins of this invention utilizes bis-(hydroxyethyl)-terephthalate, purified from the reaction product of glycolysis of post-consumer polyester waste—this monomer can be added to the polymerization process, preferably prior to the polycondensation stages.

The polyester compositions suitable for use in this invention include those having an intrinsic viscosity of at least about 0.90 dl/g, preferably at least about 1.0 dl/g, and more preferably between about 0.9 and about 1.2 dl/g. Lower intrinsic viscosity resins have insufficient melt strength for an EBM process, whereas higher intrinsic viscosity resins have too high a melt viscosity at the extrusion temperatures above which there is thermal degradation and a loss of molecular weight.

### Branched Aliphatic Glycol

The preferred examples of a branched aliphatic glycols suitable for this invention include 2-methyl-1,3-propane diol, 2-ethyl-1,3-propane diol, 2-butyl-1,3-propane diol, 2,2′-dimethyl-1,3-propanediol, 2-methyl-1,4-butanediol, 2-ethyl-1,4-butanediol, 2-butyl-1,4-butanediol, 3-methyl-1,5-pentanediol, 2,4-dimethyl-1,5-pentanediol or mixtures thereof. The most preferred branched aliphatic glycol is 2, 2′-dimethyl-1, 3-propanediol. The amount of the branched aliphatic glycol is preferably in the range of about 2.0 mole % to about 10.0 mole %, preferably about 3.0 mole % to about 7.0 mole %, based on the total mole % of glycols residues in the composition. Lower amounts of the branched aliphatic glycols do not retard the crystallization rate sufficiently to be used for the EBM process without the container becoming hazy after cooling in the mold. Higher amounts of the branched aliphatic glycols do not give the high melt strength required in the EBM process.

### Branching Comonomer

The branching comonomer present in the composition has 3, or more, carboxyl substituents, hydroxyl substituents, or a combination thereof. Examples of branching monomers include, but are not limited to, multifunctional acids or multifunctional alcohols such as trimellitic acid, trimellitic anhydride, pyromellitic dianhydride, benzene-1,3,5-tricarboxylic acid, trimethylolpropane, glycerol, sorbitol, 1,2,6-hexanetriol, pentaerythritol, citric acid, tartaric acid, 3-hydroxyglutaric acid, trimesic acid and the like. Ethoxylated or oxypropylated triols can also be used. In the preferred embodiment, the branching monomer residues are chosen from at least one of the following: pentaerythritol, trimethylolpropane, trimethylolethane, trimellitic acid, trimellitic anhydride and/or benzene-1, 3, 5-tricarboxylic acid. The branching comonomer can be present in an amount ranging from 50 to 2000 μmol based on the copolyester.

### Extrusion Blow Molding

In another aspect, this invention relates to a process for preparing extrusion blow molded containers. The extrusion blow molding process can be accomplished via any EBM manufacturing process known in the art. Although not limited thereto, a typical description of extrusion blow molding manufacturing process involves: 1) melting the resin in an extruder 2) extruding the molten resin through a die to form a tube of molten polymer (i.e. a parison) 3) clamping a mold having the desired finished shape around the parison 4) blowing air into the parison, causing the extrudate to stretch and expand to fill the mold 5) cooling the molded container 6) ejecting the container from the mold and 7) removing excess plastic (commonly referred to as flash/flashing) from the container.

The term “container” as used herein is understood to mean a receptacle in which material is held or stored. Containers include, but are not limited to, bottles, bags, vials, tubes, and jars. Applications in the industry for these types of containers include, but are not limited to, food, beverage, cosmetics, household or chemical containers, and personal care applications. The term “bottle”, as used herein, is understood to mean a receptacle containing resin which is capable of storing or holding liquid.

The exact resin formulation must provide a melt such that when extruded has a high melt strength capable of resisting stretching and flowing, sagging, or other undesirably aspects that would lead to uneven material distribution in the parison and thinning of the parison walls. Melt strength is directly related to the polyester resin's viscosity, under zero shear rate, and temperature when the molten extrudate exits the die. However, a resin with high melt strength, or high melt viscosity at zero shear rate, is too viscous to be extruded in the extruder and pumped through the die without using high temperatures which cause the polymer to degrade and lose its melt viscosity. Therefore an optimal polyester resin, designed for EBM end uses, must have a rheology such that the viscosity at the shear rates associated with the extrusion process, generally 100 to 1000 s⁻¹, is lower than the viscosity at zero shear rate (i.e. exhibits shear thinning). The melt strength can be measured using a Melt Indexer which extrudes the resin through a capillary die at a zero shear rate. The length of the extrudate after a period of time (L₁) can be compared with the length after the same period of time (L₂). The ratio of L₂/L₁, melt strength, gives a measure of the sag of the extrudate, this ratio being 1.0 if there is no sag. This ratio increases as the melt strength becomes weaker and L2 increases as the extrudate cannot support its own weight. For the inventive EBM resins the melt strength should be the range of about 1 to about 1.6 when measured at an extrusion temperature corresponding to a melt index of 2.6±0.2 g/10 min under a load of 2.16 kg.

In addition, during the EBM process, the molten polyester should not thermally crystallize; otherwise, a cloudy container is produced. The EBM process produces waste from the flash that has to be cut from the molded container where, for instance, it has been clamped. This waste from the EBM process must be ground and mixed with the virgin resin and dried prior to re-extrusion. Therefore, the designed resin of interest has to possess and maintain a low level of crystallinity such that it does not agglomerate during drying.

In order to pass the APR Critical Guidance protocol for use in the postconsumer clear polyester recycle stream, the polyester resins of this invention must be semi-crystalline (i.e. exhibit a melting endotherm as detected by Differential Scanning calorimetry). In this regard, the melting point for an EBM resin should be in the range of 235-255° C.

Another parameter that must be met by the resin relates to the drop resistance of an EBM container filled with liquid when dropped from a height of 4 feet (122 cm). After such a drop test, it is expected that no more than one out of ten containers break, split or leak. As copolyesters age with time, it is important that the drop resistance is measured after several weeks, e.g. 4 to 6 weeks, from manufacture.

### Test and Preparative Methods

1. Test Methods

The Intrinsic Viscosity of the polyesters are measured according to ASTM D 460396, and reported in units of dl/g.
a. The melting point of the polyesters was taken as the peak of the melting endotherm of the copolyester as measured in accordance with ASTM D 3418-03. The sample was heated from 30 to 300° C. at a rate of 10° C./min, held for 5 minutes and rapidly quenched to 10° C. (at an approximate rate of 320° C./sec). The sample was then heated at 10° C./min to 300° C. and the peak melting endotherm temperature recorded.
b. The drop resistance of the containers was measured according to ASTM D 2463-95, procedure B, Bruceton Staircase Method. The containers were filed with 1.5 liter of water (23° C.) prior to dropping. The containers were stored at 23° C. and 50% Relative Humidity for aging (1 day, 1 week, 2 weeks, 3 weeks, 4 weeks, etc.).
c. The melt strength of the polymer was measured using ASTM D 1238-04c, Standard Test Method for Melt Flow Rates of Thermoplastics by Extrusion Plastometer. The temperature used for this measurement was that which corresponded to a Melt Flow Index for the polymer of 2.6±0.2 g/10 min, using a load of 2.16 kg. The length of the extrudate (L₁) after 50 sec was measured, and the total length (L) after 100 sec was measured, The length extruded in the second 50 sec (L₂) was calculated from L₁ and L:

L₂=L−L₁,
and the melt strength is defined as L₂/L₁.
d. The multifunctional hydroxyl branching comonomer content of the polymer was determined by hydrolyzing the polymer with an aqueous solution of ammonium hydroxide in a sealed reaction vessel at 220+5° C. for approximately two hours. The liquid portion of the hydrolyzed product was then analyzed by gas chromatography. The gas chromatography apparatus was a FID Detector (HP5890, HP7673A) from Hewlett Packard. The ammonium hydroxide was 28 to 30% by weight ammonium hydroxide from Fisher Scientific and was reagent grade.
e. The content of the diacids and diols, including DEG (diethylene glycol), in the polymer was determined from proton nuclear magnetic spectra (1H MNR), using a JOEL ECX-300, 300 MHz instrument. General sample preparation was as follows
   20 mg of polyester is placed in a suitable 2 mL glass reaction vessel or vial with 1 mL of 10:1 chloroform-d:TFA-d [Cambridge Isotope Laboratories, Inc. Chloroform-d (d, 98.9%)+0.05% V/V TMS: Cambridge Isotope Laboratories, Inc. Trifluoroacetic acid-d (d, 99.5%)] and capped. The reaction vessel/vial is placed on a heating block at a temperature of 100° C. for approximately 10 minutes, or until sample is fully solvated. The sample is then removed from the heat block and placed in the hood to equilibrate to RT. The solvated sample is then transferred to a standard NMR tube and analyzed via a pre-defined NMR experimental protocol. Resultant spectral integrations were worked-up via Excel macros in order to determine the reported monomer contents.

2. Preparative Methods

Extrusion Blow Molded (EBM) Bottles

A 90 mm Bekum H-155 Continuous EBM Machine fitted with a Glycon DM2 screw was used to produce model EBM containers. These containers were standard 1.75 liter, rectangular handleware containers weighing 110 g. The extrusion temperature was adjusted between 245 and 260° C. to obtained an even polymer distribution in the containers. The copolyesters were dried to a moisture level of less than 50 ppm prior to extrusion.

Preparation of Polyesters

A series of copolyesters were prepared from purified terephthalic acid, isophthalic acid ethylene glycol, aliphatic branched acid, pentaerythritol, with antimony trioxide as the polycondensation catalyst using standard operating procedures known in the art. The amorphous IV of these copolyesters was in the range of about 0.66 to about 0.68 dl/g.

These amorphous copolyesters were further polymerized in the solid state in order to achieve the target IV.

### Examples

The composition and properties of the polyesters used in the Examples are set forth in Table 1. Comparative Examples represent prior art EBM polyester resins. The abbreviations for the monomers used in these compositions are:

| | |
|---|---|
| PTA | purified terephthalic acid |
| PIA | purified isophthalic acid |
| DEG | diethylene glycol |
| DPD | 2,2′-dimethyl-1,3-propanediol |
| MPD | 2-methyl-1,3-propane diol |
| Penta | pentaerythritol |

The remaining glycol added in these compositions is ethylene glycol and diethylene glycol formed during polymerization. The amount of the monomers is expressed as mole %, based on the moles of the diacids or glycols as applicable, and the branching comonomer as μmol.

TABLE 1

| | PIA, | DPD, | MPD, | DEG, | | | |
|---|---|---|---|---|---|---|---|
| | mole | mole | mole | mole | Penta, | IV, | Melting |
| Example | % | % | % | % | μmol | dl/g | Pt., ° C. |
| Comp 1 | 7.2 | 0 | 0 | 1.3 | 386 | 1.04 | 230 |
| Comp 2 | 5.5 | 0 | 0 | 1.7 | 0 | 1.27 | 231 |
| Inventive 1 | 0 | 3.9 | 0 | 2.0 | 431 | 1.03 | 238 |
| Inventive 2 | 0 | 5.0 | 0 | 1.4 | 116 | 1.11 | 233 |
| Inventive 3 | 0 | 4.9 | 0 | 1.9 | 84 | 1.01 | 232 |
| Inventive 4 | 0 | 4.0 | 0 | 1.4 | 84 | 0.99 | n.m. |
| Inventive 5 | 0 | 0 | 3.7 | 2.1 | 92 | 1.00 | 240 |
| Comp 3 | 0 | 4.2 | 0 | 4.6 | 323 | 1.02 | n.m. |
| Comp 4 | 0 | 6.4 | 0 | 2.1 | 90 | 1.05 | 229 |
| Comp 5 | 0 | 4.0 | 0 | 1.7 | 134 | 1.04 | 236 |

The melt strength of these resins is set forth in Table 2.

TABLE 2

| | Extrusion | Melt Index, | Melt |
|---|---|---|---|
| Example | Temp., ° C | g/10 min | strength |
| Comp. 1 | 265 | 2.75 | 1.35 |
| Comp. 2 | 277 | 2.69 | 1.76 |
| Inventive 1 | 268 | 2.50 | 1.29 |
| Inventive 2 | 259 | 2.73 | 1.45 |
| Inventive 3 | 255 | 2.69 | 1.59 |
| Comp. 3 | 270 | 2.55 | 1.30 |
| Comp. 4 | 251 | 2.41 | 1.32 |
| Comp. 5 | 257 | 2.59 | 1.41 |

Bottles were prepared from these resins and the process conditions required to make a bottle with the required dimensions are set forth in Table 3. It was noted that when running comparative example 2 there was more oligomer deposits on the EBM machine.

TABLE 3

| | Melt | Melt Press., | Motor |
|---|---|---|---|
| Example | Temp., ° C | MPa | Load, % |
| Comp. 1 | 266 | 13.8 | 45 |
| Comp. 2 | 263 | 20.7 | 85 |
| Inventive 1 | 266 | 8.6 | 56 |
| Inventive 2 | 249 | 14.4 | 80 |
| Inventive 3 | 248 | 17.1 | 70 |
| Inventive 4 | 246 | 12.9 | 71 |
| Inventive 5 | 233 | 5.6 | 41 |
| Comp. 3 | 265 | 9.2 | 57 |
| Comp. 4 | 246 | 17.4 | 67 |
| Comp. 5 | 257 | 12.3 | 68 |

The inventive examples could be processed at lower temperatures, melt pressure and motor loads giving a wider operating window than prior art comparative examples 1 and 2.

The drop resistance of freshly made and aged EBM bottles is set forth in Table 4.

TABLE 4

Mean Drop Height, cm

| Example | 1 day | 1 week | 2 week | 4 week |
|---|---|---|---|---|
| Comp. 1 | 165 | 140 | 117 | 107 |
| Comp. 2 | 178 | 155 | 170 | 168 |
| Inventive 1 | 191 | 152 | 188 | n.m. |
| Inventive 2 | 185 | 181 | 198 | 198 |
| Inventive 3 | 196 | 201 | 193 | 187 |
| Inventive 4 | 198 | 203 | 188 | 188 |
| Inventive 5 | 198 | 185 | 165 | 195 |
| Comp. 3 | 197 | 185 | 152 | n.m. |
| Comp. 4 | 201 | n.m. | 191 | 157 |
| Comp. 5 | 186 | 198 | 196 | 102 |

The bottle aged drop resistance of the inventive examples is superior to the comparative examples.

A series of trials were conducted to determine the sensitivity of the aged bottle drop performance over a range of molecular weight (IV) at a constant 5.7 mole % of DPD, 1.4 mole % DEG and 85 μmol of Penta. The EBM extrusion conditions are set forth in Table 5, and the drop resistance of freshly made and aged EBM bottle is set forth in Table 6.

TABLE 5

| | IV, | Melt | Melt Press., | Motor |
|---|---|---|---|---|
| Example | dl/g | Temp., ° C | MPa | Load, % |
| Inventive 6 | 0.96 | 241 | 11.3 | 62 |
| Inventive 7 | 1.01 | 249 | 14.4 | 66 |
| Inventive 8 | 1.06 | 248 | 17.1 | 74 |
| Inventive 9 | 1.03 | 238 | 15.1 | 70 |

TABLE 6

Mean Drop Height, cm

| Example | 1 day | 1 week | 2 weeks | 4 weeks |
|---|---|---|---|---|
| Inventive 6 | 201 | 201 | 203 | 203 |
| Inventive 7 | 206 | 198 | 201 | 203 |
| Inventive 8 | 206 | 203 | 206 | 213 |
| Inventive 9 | 154 | 194 | 188 | 203 |

These results show that the drop resistance of EBM bottles made from alkyl branched aliphatic diols do not age, compared to the prior art EBM recipes that use an ultra-high IV and an aromatic or cycloaliphatic crystallization retardant, or a higher content of a branching comonomer.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is claimed is:

1. A copolyester for an extrusion molded container comprising:
(a) An aromatic dicarboxylic acid component comprising 95 to 100 mole % of dicarboxylic acid residues based on the total mole % of dicarboxylic acid residues in the polyester compositions;
(b) a glycol component comprising:
(i) 90 to 98 mole % of ethylene glycol residues based on the total mole % of glycol residues in the polyester compositions, and
(ii) 2 to 10 mole % of an aliphatic branched glycol represented by the following Formula I: 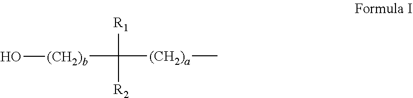
where R₁ is a hydrogen atom or an alkyl group having 1 to 6 carbon atoms, and
R₂ is an alkyl group having 1 to 6 carbon atoms, and
a and b are each independently an integer from 1 to 2, and
(c) a branching comonomer.

2. The copolyester of claim 1, wherein the aromatic dicarboxylic acid residues comprise terephthalic acid, 2,6-naphthalene dicarboxylic acid, or mixtures thereof.

3. The copolyester of claim 1, wherein the glycol component further comprises diethylene glycol.

4. The copolyester of claim 1, wherein the branching agent is present in the amount of between 50 to 2000 μmol, based on the copolyester.

5. The copolyester of claim 1, wherein the aromatic dicarboxylic acid component further comprises up to 5 mole % of one or more modifying aromatic dicarboxylic acids chosen from 4,4′-biphenyldicarboxylic acid, 1,4-naphthalene dicarboxylic acid, 1,5-naphthalene dicarboxylic acid, 2,6-naphthalene dicarboxylic acid, 2,7-naphthalenedicarboxylic acid, trans-4,4′-stilbenedicarboxylic acid, heterocyclic dicarboxylic acid and esters thereof.

6. The copolyester of claim 1, further comprising an intrinsic viscosity of at least about 0.90 dl/g.

7. The copolyester of claim 1, further comprising at least one additive chosen from colorants, toners, dyes, mold release agents, flame retardants, plasticizers, stabilizers, impact modifiers, or a mixture thereof.

8. The copolyester of claim 1, further comprising up to 5 mole % of one or more aliphatic dicarboxylic acids chosen from malonic, succinic, glutaric, adipic, pimelic, suberic, octanoic, azelaic, sebacic, dodecanedioic-dicarboxylic acids, diethyl-di-n-propyl malonate, dimethyl benzylmalonate, 2,2-dimethyl-malonic acid and 2,3-dimethyl glutaric acid.

9. An extrusion blow molded process for forming a container, comprising:
(a) melt blending a resin comprising:
(i) an aromatic dicarboxylic acid component comprising 95 to 100 mole % of dicarboxylic acid residues based on the total mole % of dicarboxylic acid residues in the polyester compositions;
(ii) a glycol component comprising:
90 to 98 mole % of ethylene glycol residues based on the total mole % of glycol residues in the polyester compositions, and 2 to 10 mole % of an aliphatic branched glycol represented by the following Formula I: 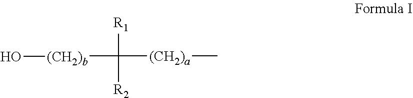
where R₁ is a hydrogen atom or an alkyl group having 1 to 6 carbon atoms, and
R₂ is an alkyl group having 1 to 6 carbon atoms, and
a and b are each independently an integer from 1 to 2, and
(iii) a branching comonomer,
(b) forming a parison;
(c) blowing the parison into the shape of the container;
(d) removing scrap polymer composition.

10. The extrusion blow molded process according to claim 9, wherein the aromatic dicarboxylic acid residues comprise terephthalic acid, 2,6-naphthalenedicarboxylic acid, or mixtures thereof.

11. The extrusion blow molded process according to claim 9, wherein the glycol component further comprises diethylene glycol.

12. The extrusion blow molded process according to claim 9, further comprising grinding the scrap polymer composition and then mixing with the resin in step (a).

13. The extrusion blow molded process according to claim 9, wherein the melting point of the resin is between 235° C. to 255° C.

14. The extrusion blow molded process according to claim 9, wherein the container is a bottle.

15. An extrusion blow molded container comprising a copolyester which comprises:
(a) an aromatic dicarboxylic acid component comprising 95 to 100 mole % of dicarboxylic acid residues based on the total mole % of dicarboxylic acid residues in the polyester compositions;
(b) a glycol component comprising:
(i) 90 to 98 mole % of ethylene glycol residues based on the total mole % of glycol residues in the polyester compositions, and
(ii) 2 to 10 mole % of an aliphatic branched glycol represented by the following Formula I: 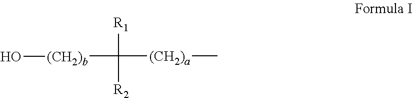
where R₁ is a hydrogen atom or an alkyl group having 1 to 6 carbon atoms, and
R₂ is an alkyl group having 1 to 6 carbon atoms, and
a and b are each independently an integer from 1 to 2, and
(c) a branching comonomer.

16. The extrusion blow molded container according to claim 15, wherein the branching agent is present in the amount of between 50 to 2000 μmol, based on copolyester.

17. The extrusion blow molded container according to claim 15, wherein the dicarboxylic acid residues comprise terephthalic acid, 2,6-naphthalene dicarboxylic acid, or mixtures thereof, and the glycol residues comprise ethylene glycol, diethylene glycol or mixtures thereof.

18. The extrusion blow molded container according to claim 15, further comprising a drop height of more than 160 cm when tested according to ASTM D 2463-95, procedure B, Bruceton Staircase Method, after four weeks.

19. The extrusion blow molded container according to claim 15, wherein the copolyester further comprises an intrinsic viscosity of at least about 0.90 dl/g.

20. The extrusion blow molded container according to claim 15, wherein the container is a bottle.
